(19) United States
(12) Patent Application Publication
(10) Pub. No.: US 2018/0210195 A1
(43) Pub. Date: Jul. 26, 2018

(54) AVOIDING GHOST IMAGES

(71) Applicant: Microsoft Technology Licensing, LLC, Redmond, WA (US)

(72) Inventors: Poon Yarn Chee, Sammamish, WA (US); Joshua Owen Miller, Woodinville, WA (US); Cynthia Sue Bell, Kirkland, WA (US); Michael J. Nystrom, Mercer Island, WA (US)

(73) Assignee: Microsoft Technology Licensing, LLC, Redmond, WA (US)

(21) Appl. No.: 15/414,503

(22) Filed: Jan. 24, 2017

(51) Int. Cl. G02B 27/00; G02B 27/01; G02B 1/11; G02B 5/00; F21V 9/14

(52) U.S. Cl. CPC G02B 27/0018; G02B 27/0172; G02B 1/11; F21Y 2115/10; F21V 9/14; G02B 2027/012; G02B 5/003

(57) ABSTRACT

Examples are disclosed herein that relate to reducing reflectivity in a micro-LED array in a display device to avoid ghost images. One example provides a method comprising forming a structure comprising a plurality of light emitters arranged to form a scannable light-emitter array, and forming a material having a lower reflectivity than inactive regions located between the light emitters.

### BACKGROUND

Near-eye display devices and other display devices may utilize microdisplays based on technologies such as liquid crystal on silicon (LCOS), micro-LED arrays or digital light processing (DLP) to produce images for display.

### SUMMARY

Examples are disclosed herein that relate to reducing reflectivity in a micro-LED array in a display device to avoid ghost images. One example provides a method comprising forming a structure comprising a plurality of light emitters arranged to form a scannable light-emitter array, and forming a material having a lower reflectivity than inactive regions located between the light emitters.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example use scenario for a near-eye display device.

FIG. 2 schematically shows an example micro-LED array.

FIG. 3 schematically shows an example optical display system utilizing a micro-LED array.

FIGS. 4-9 show example methods of reducing reflectivity in a micro-LED array.

FIG. 10 shows a flow diagram depicting an example method of reducing reflectivity in a micro-LED array.

FIG. 11 shows a flow diagram depicting another example method of reducing reflectivity in a micro-LED array.

FIG. 12 shows a flow diagram depicting another example method of reducing reflectivity in a micro-LED array.

FIG. 13 shows an example packaging for a micro-LED array.

### DETAILED DESCRIPTION

As mentioned above, some display devices may utilize LCOS or DLP panels as image sources. These devices modulate light that is received from a light source. However, optical systems utilizing such image producing elements may be bulky for a near-to-eye display, such as a head-mounted display system, in part due to the separate light source and illumination optics that must precede the display panels. Further, the reflectivity of a LCOS may be on the order of 35-55%, which may result in a relatively high percentage of light from the source not reaching a viewer. In addition to the poor efficiency, the display image reflects off surfaces in the projection path and returns to the LCOS backplane, creating ghost images that are re-projected and bright enough to be visible to users, degrading augmented reality (AR) image quality.

To address such issues, a light emitter array may be used in combination with scanning optics to display an image. Such a light emitter array may comprise areas of light emitters, such as micro-LED dies, clusters of micro-LED emitters, strips of micro-LED emitters, or other suitable emitters (e.g. laser diodes) that are separately mounted onto a driver backplane, such as a CMOS or TFT backplane. Compared to conventional LEDs which measure hundreds of micrometers on a side, micro-LEDs are significantly smaller, on the order of 1 to 25 micrometers on a side. They may be manufactured as either top or side emitters, as a superluminescent diode (SLED) designs, or other variations. An image may be displayed by controlling which micro-LEDs are powered on or off at each scanned pixel. Such an optical system may be more compact and efficient than an LCOS-based display. While described herein in the context of micro-LED arrays, other suitable emitter arrays, including but not limited to laser diode arrays, also may be used in the examples described herein.

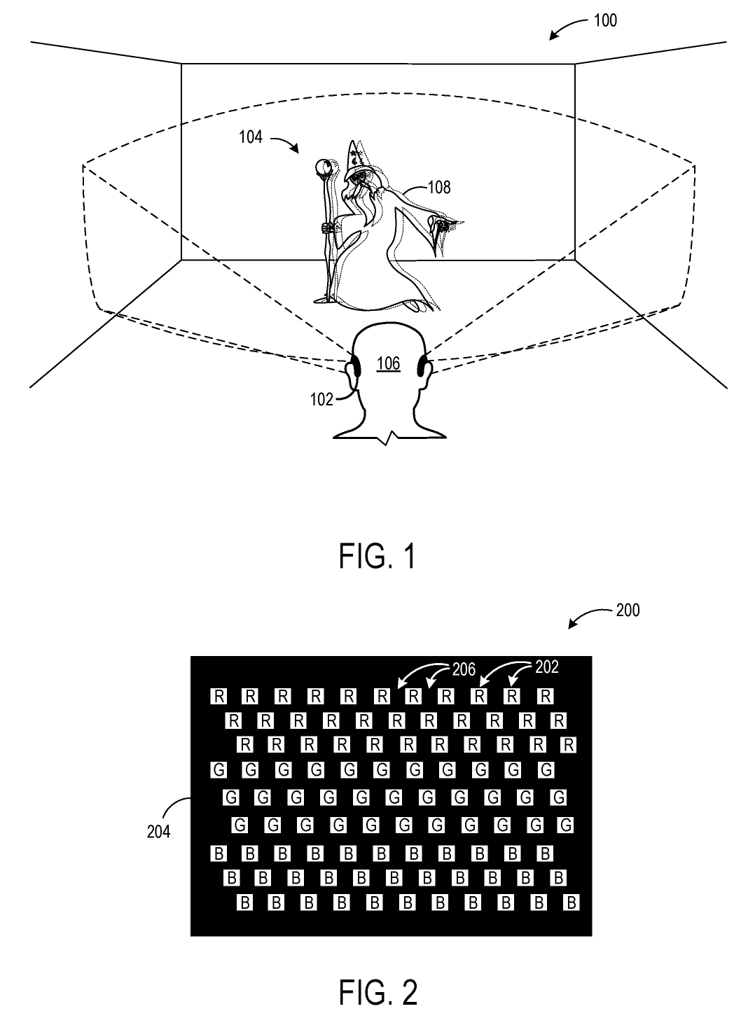

However, the same potential ghost problem may arise with the use of micro-LEDs in near-eye displays as with LCOS devices, as a first-surface reflection at a waveguide or other optical surface(s) that may produce at least some level of back-reflection. A reflected image from such optical surfaces may travel back through the projection and scanning optics to the light emitter array backplane. As the driver backplane may be formed from a partially reflective material, such as silicon (e.g. in CMOS implementations) or glass (e.g. in TFT implementations), and have a relatively sparse arrangement of light emitters, areas of the driver backplane surface not covered by light emitters, as well as inactive emitter-adjacent surfaces including light emitter die substrate areas, may reflect such light back through the display optics, thus creating a ghost image that can be seen by a user. FIG. 1 shows an example use scenario 100 for a near-eye display device 102 in the form of a head-mounted display device. In this scenario, the near-eye display device 102 is displaying a virtual object 104 to a wearer 106, and a ghost image 108 of the virtual object 104 is also visible to the wearer 106 due to the above-described back-reflection issues.

Accordingly, examples are disclosed herein that relate to configuring the backplane of a light emitter array such that areas between the emitters have reduced reflectivity. It will be understood that the term backplane as used herein may refer to the driver backplane (e.g. silicon or glass) as well as the light emitter die substrate areas not covered by light emitters. Reducing the reflectivity of the backplane may help to prevent the reflection of light back into a waveguide or other relay optic and thereby avoid the creation of ghost images. The relatively sparse arrangement in which the emitters are mounted to the backplane in such a structure may facilitate the suppression of ghost images in such a device compared to an LCOS, in which the pixels are in a dense arrangement. As described in more detail below, reducing the reflectivity in areas of the backplane between the light emitters may include depositing an absorbing material on the backplane, modifying the backplane material, removing material from the backplane, adding an absorbing mask over the non-emissive regions, utilizing an optically transmissive backplane, and/or other suitable techniques or combination of techniques.

As mentioned above, light emitter arrays may be mounted on various different driver backplanes, such as semiconductor and glass backplanes. As such, different reflectivity reduction techniques may be used for different backplane configurations. However, it will be understood that the described examples are not intended to be limited to the specific backplane contexts in which the examples are described, but rather may be utilized in any suitable implementations with any suitable backplanes.

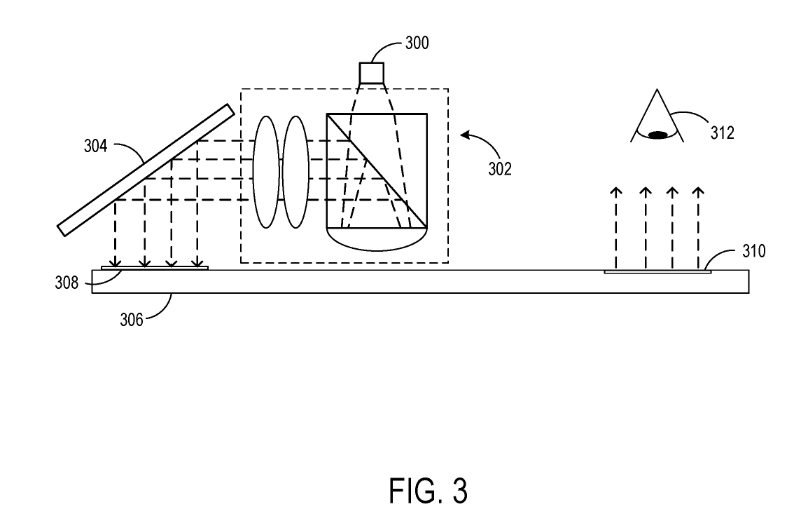

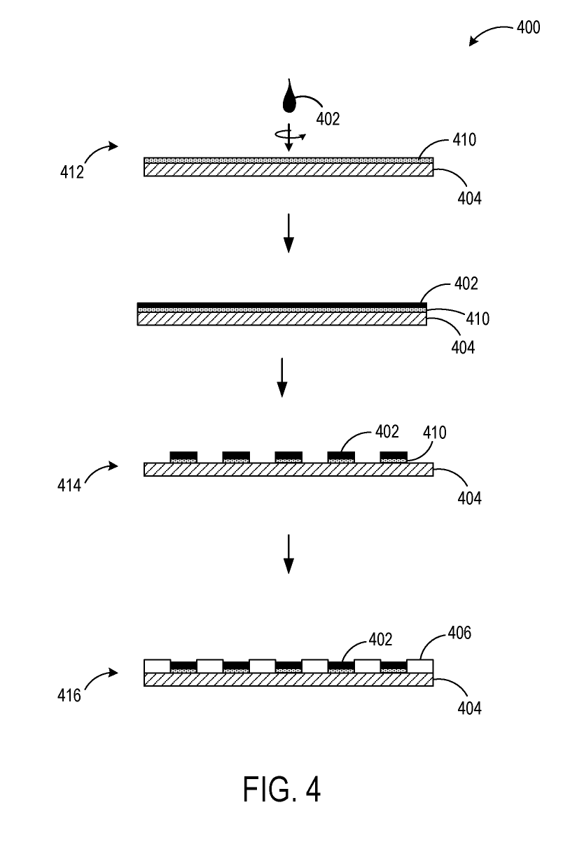

FIG. 2 schematically shows an example micro-LED array 200 comprising a plurality of micro-LED dies 202, with one micro-LED emitter per die, mounted on a backplane 204, where the backplane 204 has a reduced reflectivity in areas 206 between the micro-LED dies 202. Such a micro-LED array 200 may be used as a light source in a scanning display system, an example of which is shown in FIG. 3. In FIG. 2, multiple staggered rows of micro-LED emitters, such as red, green, and blue (shown as R, G, and B respectively) micro-LED emitters, on the micro-LED dies 202 are mounted to the backplane 204. This configuration may help to prevent the appearance of visible dark spots in the image. However, any other suitable configuration of micro-LED emitters and dies may be used for a micro-LED array in other implementations. For example, rather than one micro-LED emitter per die, strips or clusters of micro-LEDs may be applied per die.

Referring briefly to FIG. 3, light from a micro-LED array 300 (which may take the form of micro-LED array 200 in some examples) is input into optics 302, which collimates and redirects the light. The light is then scanned by scanning element 304, and coupled into a waveguide 306 via input coupling 308. The light then propagates through the waveguide via total internal reflection to an output coupling 310, which outputs the light toward a user's eve 312. As mentioned above, some light may be reflected from the input coupling 308 back toward the micro-LED array 300. If this light is then reflected back toward the waveguide 306 by the micro-LED array backplane, a ghost image may result. Thus, reducing the reflectivity of the backplane may help to prevent such problems in the depicted optical system.

Various techniques may be used to reduce reflectivity in areas of the backplane between the micro-LED dies. For example, a material layer having a lower reflectivity than the backplane may be formed on the backplane, e.g. by deposition, chemical transformation, and/or other suitable processing. In some examples, such a material may be formed on the backplane prior to mounting the micro-LED dies, while in other examples the material may be formed after mounting the micro-LED dies.

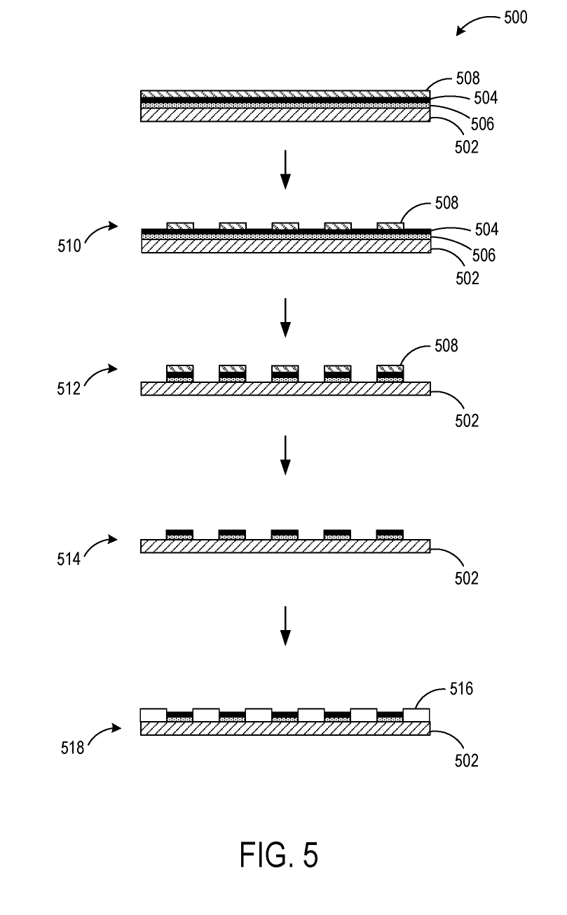

FIG. 4 schematically illustrates, from a side sectional view, an example method 400 of forming a layer of a material 402 having lower reflectivity than the backplane 404 prior to mounting micro-LED dies 406. Before forming the layer of material with the lower reflectivity, an initial planarization step may be performed, in which a planarizing 410, such as a glass layer of silicon nitride or silicon dioxide, is applied to the backplane 404. This may help to smooth the surface of the backplane 404 to facilitate later processing steps. FIG. 4 omits any depiction of circuit elements of the backplane 404 for clarity.

Next, at 412, a layer of the material 402 having a lower reflectivity than the backplane 404 is applied to the planarization layer 410, e.g. via spin or slot coating or other suitable technique. In some examples, the material 402 contains colorants (dyes and/or pigments) that absorb light in the visible range. The material 402 further may include other components, such as a dispersant polymer to help uniformly spread the pigments, a polymerizable monomer that allows the material 402 to be hardened and patterned, a photoinitiator or other suitable polymerization initiator, an alkaline-soluble polymer that may help to control coating development properties, and/or other suitable components. In other examples, the material 402 may comprise an absorbing epoxy or acrylic layer. In yet other examples, any other suitable materials may be utilized. Suitable materials include those that are able to be patterned, that are optically absorbing, and that are compatible with silicon processing. One example of an optically absorbing material is the black Color Mosaic material available from Fujifilm Corporation of Tokyo, Japan.

After coating, the material 402 may be dried in a baking step, and then exposed to curing energy (e.g. ultraviolet light) through a negative mask (not shown) in a photopolymerization curing step, which forms an insoluble polymer from the polymerizable monomer. The material 402 thus is cured in the exposed areas, and remains soluble in unexposed areas. Unexposed areas of material 402 may then he removed, and the remaining patterned material 402 may be rinsed and post-baked. In other examples, a positive patterning process may be utilized. Patterned material 402 on the backplane 404 is shown at 414. Portions of the planarization layer 410 also may be removed (e.g. via a suitable etching process), revealing areas of the backplane available for mounting the micro-LED dies 406, as also shown at 414. In other examples, any other suitable patterning process may be used to form the optically-absorbing layer.

After removing the undesired portions of the material 402 and planarization layer 410, the micro-LED dies 406 may be applied as one-dimensional sub-arrays (e.g. as strips each comprising multiple micro-LED emitters on a die substrate), as two-dimensional sub-arrays, or as individual micro-LED dies (one micro-LED emitter per die). The micro-LED dies may be bonded to the backplane 304 via conventional bonding processes, die-to-die interconnect processes, by wave soldering or any other suitable process. In other examples, micro-LED emitters may be bonded to the backplane prior to patterning the optically-absorbing layer. For example, a black patternable resist may be applied over the mounted micro-LED, emitters, and then may he etched in the areas covering the micro-LED emitters.

FIG. 5 shows another example method 500 of forming an optically absorbing layer on a backplane 502 by adhering a material 504 to an adhesive 506 attached to the backplane 502 in areas between the LED dies 516. Material 504 may take any suitable form, including but not limited to optically absorbing carbon nanotube films, light absorbing black-out material, anodized and/or carbon-surfaced materials.

Method 500 includes first applying to the backplane 502 a layer of adhesive material 506, a layer of the optically absorbing material 504 which adheres to the adhesive 506, and a photoresist layer 508. The photoresist 508 is then patterned, as shown at 510, using lithographic techniques. Next, at 512, the optically absorbing material 504 and the adhesive 506 are removed, e.g. via chemical or physical processes, revealing areas of the backplane 502 for mounting micro-LED dies. The photoresist 508 is then removed, at 514, and micro-LED dies 516 arc mounted and suitable bonded, at 518.

In other examples, an optically absorbing layer may be applied to the backplane without the use of an adhesive. FIG. 6 shows an example method 600 of growing an optically absorbing layer 604 on the backplane 602, e.g. via chemical vapor deposition (CVD), physical vapor deposition (PVD), or other suitable film growth process. Method 600 shows, at 606, an optically absorbing layer 604 grown (e.g. via deposition) onto the backplane 602, and a photoresist layer 608 applied to the backplane 602. At 610, the photoresist film is patterned; at 612, exposed portions of the optically absorbing layer are removed; and at 614, the remaining photoresist is stripped. Then, micro-LED dies 616 are mounted to the backplane 602, at 618. Yet another example includes using an electrophoretic deposition process to apply an absorbing polymer onto an electrically conductive substrate on the backplane. In such a process, a metal layer may be applied to designated areas of the backplane prior to the application of the absorbing polymer.

In other examples, a material having a lower reflectivity than the backplane may be formed on the backplane after mounting the light emitter dies. Such methods may be used in TFT implementations, as a non-limiting example. FIG. 7 illustrates the dispensing of an optically absorbing material 702 via one or more dispensers 704 onto the backplane 700 after attachment of the light emitter dies 706. The material 702, initially in fluid form, flows around previously-mounted light emitter dies 706, and then is cured to form an optically absorbing layer over the previously-exposed backplane areas. Careful control of the dispensing of the material 702 may allow the filling of the spaces between the light emitter dies 706 to a sufficient thickness to achieve a reduction in reflectivity while not covering the light emitter dies 706. In other examples, the absorbing layer 702 may be applied before mounting the light emitter dies, e.g. by masking areas of the backplane on which the light emitter dies are to be mounted, applying and curing the layer 702, and then removing the masking material to expose the light emitter mounting areas.

In yet other examples, the optically absorbing material may be placed over a backplane as a pre-formed optically absorbing layer. FIG. 8 shows an example of placing a pre-formed layer 800 of an optically absorbing material over a backplane 802 comprising a plurality of previously-mounted light emitter dies 804. The pre-formed layer 800 comprises openings 806 in locations matched to locations of the light emitter dies 804, such that when applied onto the backplane 802, the openings 7806 accommodate the light emitter dies 804 to pass through the openings 806. The pre-formed layer 800 may be formed from any suitable material. Examples include anodized aluminum, dyed and coated plastic films and carbon-coated metal masks. The pre-formed layer 800 may be bonded to the backplane 802 in any suitable manner, such as via an adhesive that is applied to the pre-formed layer 800 and/or to the backplane 802 prior to joining the structures. In some examples, a pre-formed absorbing layer comprising openings to pass light from the light emitters may be additionally or alternatively positioned and bonded in the front of the light emitter array. In yet other examples, a pre-formed absorbing layer may be held in registration with regard to a backplane without being applied to or adhered to the backplane.

In yet other examples, rather than applying a layer onto the backplane, the backplane may have one or more regions configured to at least partially transmit incident light. As one example, material may be removed from the backplane to form openings through the backplane. FIG. 9 shows an example in which a backplane 900 has openings 902 in areas between the light emitter dies 904, such that light may be transmitted through the openings 902 in the backplane 900 rather than be reflected.

Openings 902 may be formed via any suitable method, such as via laser cutting. Openings 902 may be formed either before or mounting light emitter dies 904. LED circuitry may be routed throughout the backplane 900 in such locations as to reduce an amount of substrate surface that is used for the circuitry, thereby allowing a larger amount of material to be removed to form the openings 902. Further, an optically absorbing layer may be included behind the openings 902, e.g. on a different optical structure, to help prevent reflections from any surfaces behind the openings 902.

Instead of forming physical openings in the substrate to reduce reflectivity, in yet other examples, a transparent backplane may be utilized, and circuit structures may be located in such a manner as to form relatively large areas of transparent windows through which back-reflected light may pass. Such areas of the substrate may comprise an anti-reflective coating (e.g. a multilayer dielectric coating, Motheye coating, etc.) to prevent back-reflected light from again being reflected toward the viewer.

A polarizing film may additionally or alternatively be utilized to help reduce back-reflections. For example, in displays that utilize a waveguide, polarized light may be more efficiently coupled into the waveguide compared to unpolarized light. Thus, a polarizing film may be positioned after the micro-LED array to pre-polarize light emitted by the micro-LEDs for input into the waveguide, and to absorb back-reflected light.

In some examples, a layer of thermally conductive material may be applied in addition to an optically absorbing layer to provide thermal management properties. For example, a layer of Loctite Thermal Absorbent Film having a suitable thickness, e.g. ranging from 12 to 150 micrometers thick, may be applied to the backplane. The film may be followed by a layer of thermally-cured absorbing epoxy such as Henkel 3220, available from Henkel Corporation of Scottsdale, Ariz., or a UV-cured acrylic to provide for optical absorption in areas between the light emitter dies. In other examples, a single material may be utilized that is optically absorbing material as well as thermally conductive.

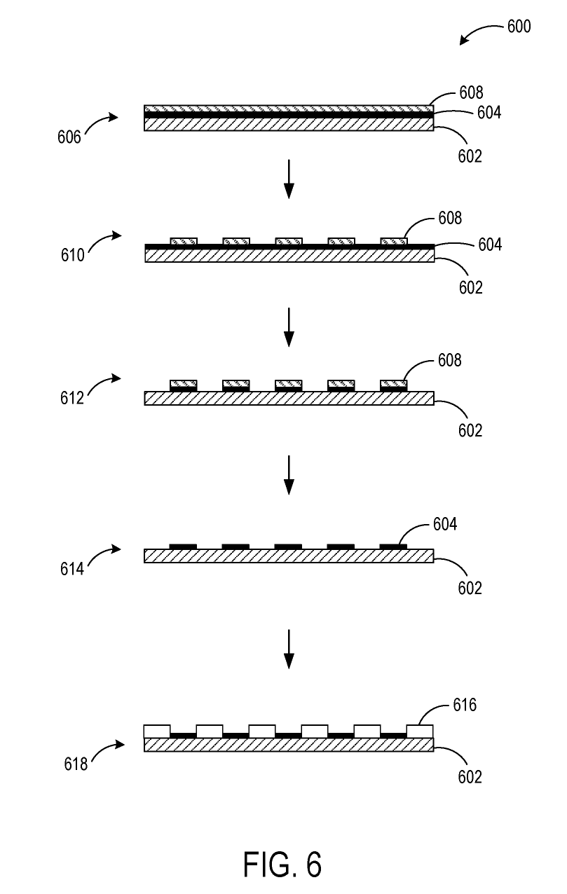

FIGS. 10-12 show flow diagrams that depict example methods of reducing reflectivity in a micro-LED display system. First referring to FIG. 10, method 1000 comprises, at 1002, forming a material having a lower reflectivity than a backplane on the backplane in areas at which light emitter dies will later be mounted. Any suitable method may be used to deposit the layer in desired areas while not covering the light emitter die mounting areas. As examples, the material may be formed by growing a film 1004 (whether by deposition or chemical transformation of a backplane surface), potentially using patterning techniques 1006, such as lithographic techniques, where suitable. The material also may be formed by adhering a previously formed material, such as carbon nanotubes, to the backplane, at 1008. The material having the lower reflectivity also may be formed by applying a pre-formed layer of the material, at 1010, e.g. as an optically absorbing film comprising openings in locations that leave the light emitter die mounting areas exposed. The method 1000 then comprises, at 1012, mounting a plurality of light emitter dies to the backplane to form the light emitter array.

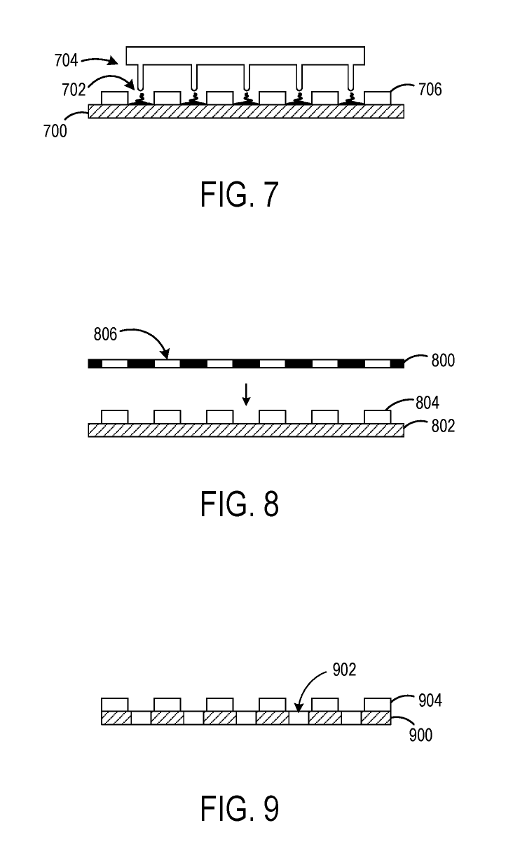

FIG. 11 shows an example method 1100 of forming a material having a lower reflectivity than a backplane. At 1102, method 1100 comprises mounting a plurality of light emitter dies and then, at 1104, forming a material having a lower reflectivity than the backplane in areas between the light emitter dies. As an example, forming the material may include dispensing the material, at 1106, in an initially fluid form, and then curing the material at 1107. The material also may be formed by applying a pre-formed layer of the material, at 1108, e.g. as an optically absorbing film comprising openings such that when applied onto the backplane, the openings accommodate the light emitter dies 804.

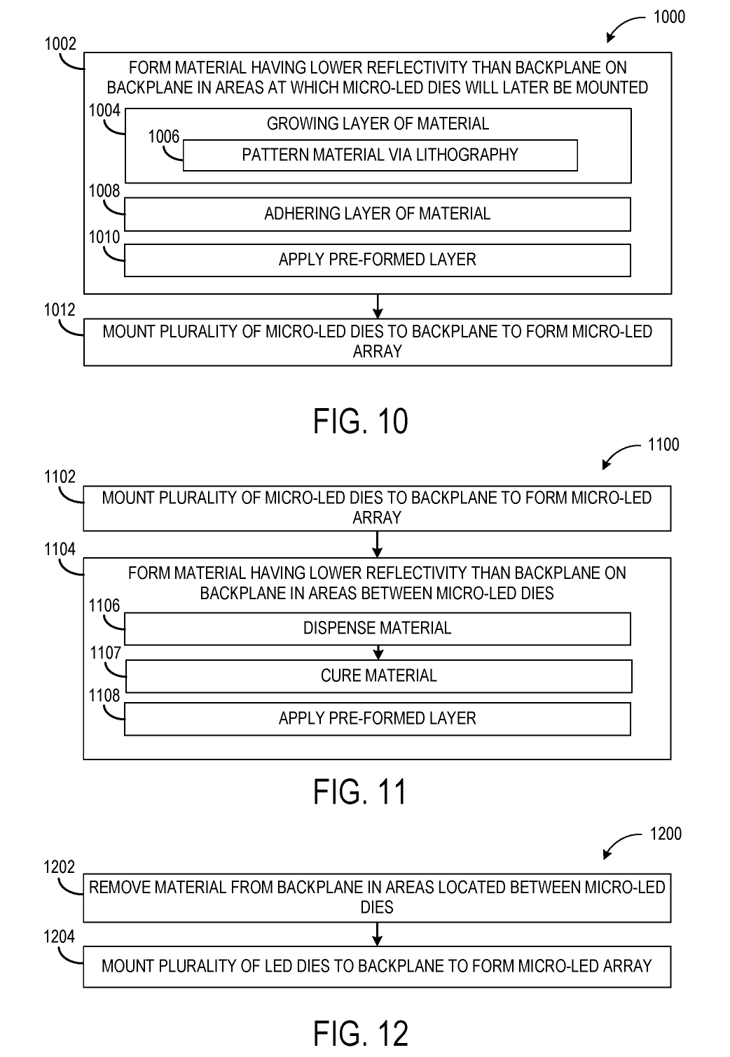

FIG. 12 shows another example method 1200 of reducing reflectivity in a light emitter array. Method 1200 includes, at 1202, removing material from the backplane in areas located between light emitter dies or light emitter die mounting areas), e.g. to form openings through the backplane in areas between the light emitter dies such that light may be transmitted through the openings Removing the material may include, for example, laser cutting. Method 1200 further includes mounting a plurality of light emitter dies to the backplane to form the light emitter array, at 1226. It will be understood that removal of material may also be done after mounting the light emitter dies.

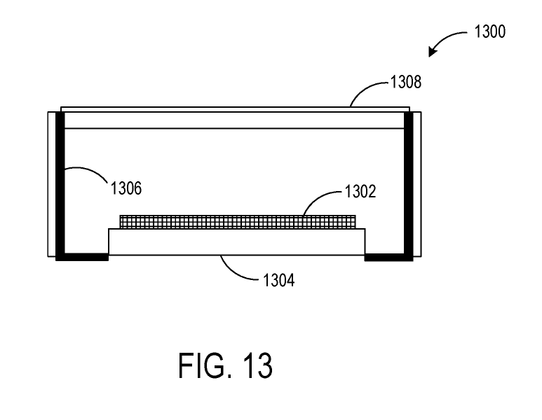

A light emitter array as described herein may be incorporated into a device in any suitable manner. FIG. 13 shows an example packaging 1300 for a light emitter array for a scanning optical system. In packaging 1300, light emitter array 1302 is shown from a side view, and may take any suitable form, such as those described above. The light emitter array 1302 is mounted on a driver backplane 1304, and an absorbing material 1306 may be applied onto one or more sides and forward-facing surfaces of the package 1302, as shown. Absorbing material 1306 may help to absorb any scattered or reflected light, e.g. from downstream scanning optical components (not shown). The packaging 1300 also includes an anti-reflective-coated glass cover 1308 to further reduce reflections.

It will be understood that any other suitable techniques may be utilized to reduce reflectivity in a backplane of a light emitter array, such as treating the backplane to reduce reflectivity,or texturing the backplane to increase optical absorption.

Another example provides a method comprising forming a structure comprising a plurality of light emitters arranged to form a scannable light-emitter array, and forming a material having a lower reflectivity than inactive regions located between the light emitters. The material having the lower reflectivity than the backplane may additionally or alternatively be formed on the backplane before mounting the light emitters to the backplane. The material having the lower reflectivity than the backplane onto the backplane may additionally or alternatively be patterned on the backplane. The material having the lower reflectivity than the backplane may additionally or alternatively be applied to the backplane after mounting light emitters to the backplane. Forming the material having the lower reflectivity than the backplane may additionally or alternatively include dispensing the material in the areas of the backplane located between the light emitters. Forming the material having the lower reflectivity than the backplane may additionally or alternatively include applying a pre-formed layer over the backplane, the pre-formed layer comprising openings in locations matched to locations of the light emitters. Forming the material having the lower reflectivity than the backplane may additionally or alternatively include growing a field of optically absorbing nanotubes on the backplane. Mounting the plurality of light emitters may additionally or alternatively include mounting multiple staggered rows of light emitters to the backplane. The material having the lower reflectivity than the backplane may additionally or alternatively include a thermal management material. The backplane may additionally or alternatively include a semiconductor substrate. The backplane may additionally or alternatively include a glass substrate.

Another example provides a method of reducing ghosting in a light engine, the method comprising mounting a plurality of light emitters to a backplane to form a light emitter array, and removing material from the backplane in areas located between the light emitters. Removing material from the backplane may additionally or alternatively include forming openings in the backplane in the areas located between the light emitters. The openings may additionally or alternatively be formed before mounting the light emitters. The openings may additionally or alternatively be formed after mounting the light emitters.

Another example provides a light emitter display device, comprising a backplane, and a plurality of light emitters mounted to the backplane, wherein the backplane comprises one or more regions configured to at least partially transmit incident light. The one or more regions may additionally or alternatively include one or more openings formed in the backplane in areas located between the light emitters. The backplane may additionally or alternatively be formed from a transparent material, and wherein the backplane further comprises an anti-reflective coating formed on at least a portion of the transparent material. The plurality of light emitters may additionally or alternatively be mounted to a front side of the backplane, and the backplane may additionally or alternatively include an optically absorbing material formed on a back side of the backplane. The light emitter display device may additionally or alternatively include a polarizing layer configured to polarize light output by the plurality of light emitters.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method comprising:
forming a structure comprising a plurality of light emitters arranged to form a scannable light-emitter array; and
forming a material having a lower reflectivity than inactive regions located between the light emitters.

2. The method of claim 1, wherein the material having the lower reflectivity than the backplane is formed on the backplane before mounting the light emitters to the backplane.

3. The method of claim 2, wherein the material having the lower reflectivity than the backplane onto the backplane is patterned on the backplane.

4. The method of claim 1, wherein the material having the lower reflectivity than the backplane is applied to the backplane after mounting light emitters to the backplane.

5. The method of claim 4, wherein forming the material having the lower reflectivity than the backplane comprises dispensing the material in the areas of the backplane located between the light emitters.

6. The method of claim 4, wherein forming the material having the lower reflectivity than the backplane comprises placing a pre-formed layer over the backplane, the pre-formed layer comprising openings in locations matched to locations of the light emitters.

7. The method of claim 1, wherein forming the material having the lower reflectivity than the backplane comprises growing a field of optically absorbing nanotubes on the backplane.

8. The method of claim 1, wherein mounting the plurality of light emitters comprises mounting multiple staggered rows of light emitters to the backplane.

9. The method of claim 1, wherein the material having the lower reflectivity than the backplane comprises a thermal management material.

10. The method of claim 1, wherein the backplane comprises a semiconductor substrate.

11. The method of claim 1, wherein the backplane comprises a glass substrate.

12. A method of reducing ghosting in a light engine, the method comprising:
mounting a plurality of light emitters to a backplane to form a light emitter array; and
removing material from the backplane in areas located between the light emitters.

13. The method of claim 12, wherein removing material from the backplane comprises forming openings in the backplane in the areas located between the light emitters.

14. The method of claim 13, wherein the openings are formed before mounting the light emitters.

15. The method of claim 13, wherein the openings are formed after mounting the light emitters.

16. A light emitter display device, comprising:
a backplane; and
a plurality of light emitters mounted to the backplane,
wherein the backplane comprises one or more regions configured to at least partially transmit incident light.

17. The light emitter display device of claim 16, wherein the one or more regions comprises one or more openings formed in the backplane in areas located between the light emitters.

18. The light emitter display device of claim 16, wherein the backplane is formed from a transparent material, and wherein the backplane further comprises an anti-reflective coating formed on at least a portion of the transparent material.

19. The light emitter display device of claim 18, wherein the plurality of light emitters are mounted to a front side of the backplane, and wherein the backplane further comprises an optically absorbing material formed on a back side of the backplane.

20. The light emitter display device of claim 17, further comprising a polarizing layer configured to polarize light output by the plurality of light emitters.
